(19) United States
(12) Patent Application Publication
(10) Pub. No.: US 2014/0016925 A1
(43) Pub. Date: Jan. 16, 2014

(54) RESIZING A PATH IN A CONNECTION-ORIENTED NETWORK

(71) Applicants: Daniele Ceccarelli, Genova (IT); Diego Caviglia, Savona (IT); Sergio Lanzone, Genova (IT)

(72) Inventors: Daniele Ceccarelli, Genova (IT); Diego Caviglia, Savona (IT); Sergio Lanzone, Genova (IT)

(73) Assignee: Telefonaktiebolaget I.M Ericsson (publ), Stockholm (SE)

(21) Appl. No.: 13/985,567

(22) PCT Filed: Apr. 18, 2011
(86) PCT No.: PCT/EP2011/056076

§ 371 Date: Oct. 3, 2013

(30) Foreign Application Priority Data
Feb. 16, 2011 (EP) 11154700.6

(51) Int. Cl. H04Q 11/00

(52) U.S. Cl. CPC H04Q 11/0062
USPC 398/5; 398/45

(57) ABSTRACT

An existing path in a connection-oriented network requires resizing from a first size to a second size. Nodes exchange control plane signalling with other nodes which advertises available resources on links between nodes. A node on the existing path receives a request to establish a path capable of being resized to the second size. The node determines, using information acquired by the control plane signalling with other nodes, a new path between nodes capable of supporting the second size. The node signals to establish the new path and switches traffic from the existing path to the new path. The node causes the new path to be resized to the second size. Nodes exchange control plane signalling with other nodes which advertises whether a link supports resizing, such as OSPF-TE advertisements.

### TECHNICAL FIELD

This invention relates to connection-oriented networks, such as Optical Transport Networks (OTN), and to resizing a path in such a network.

### BACKGROUND

Telecommunication network operators are upgrading their optical backbones to high-capacity optical networks, such as Optical Transport Networks (OTN) based on the International Telecommunications Union ITU-T G.709 hierarchy. OTN provides a hierarchy of frame structures, called Optical Data Units (ODU), for carrying traffic at different bit rates. Optical Data Units (ODU) have been created for a range of different traffic bit rates, e.g. ODU1=2.5 Gbps, ODU2=10 Gbps, ODU3=40 Gbps, ODU4=100 Gbps. In order to cope with the present and future requirements of traffic types and rates, a type of ODU container called ODUflex has also been added to the ODU hierarchy. In principle, the ODUflex can have any possible bit-rate, between ODU1 (2.5 Gbit/s) and ODU4 (100 Gbit/s).

One application for the ODUflex is the transport of a selected stream of packets within the optical network. For example, the traffic associated with a particular customer/application, identified by a particular VLAN, is mapped to a specific ODUflex. That traffic can be independently routed inside an OTN designed according to G.798 (i.e. a network made by DWDM equipments and ODUk cross-connects, where the ODUk cross-connects are able to switch ODUflex) without the need to extract traffic at the packet level every time that traffic has to be re-routed. In this way the usage of the Ethernet equipments inside the OTN can be avoided and the ODUflex path is preserved end-to-end.

ITU-T is studying a resizing protocol to improve the ODUflex flexibility. This resizing protocol (RP) will allow resizing the dimension of the ODUflex connection when the quantity of the packet traffic to be transported increases or decreases during the life of the ODUflex connection.

An ODUflex signal is transported through the optical network using a Higher Order ODUk (HO-ODUk), such as an ODU2, ODU3 or ODU4 signal. The ODUflex is mapped into the HO-ODUk using Generic Mapping Procedure (GMP). The HO-ODUk is divided in a number of Tributary Slots (TS). One restriction of an ODUflex is that, when growing in dimension, it cannot be split over different HO-ODUks. The “grown” ODUflex should always be transported by the same HO-ODUk that transports the “original” ODUflex. Therefore, when an operator sets up an ODUflex they must already foresee to keep enough free space inside the HO-ODUk, and along the whole ODUflex path within the OTN cloud, to allow the future growing of the ODUflex. The ODUflex Resizing Protocol can fail due to lack of resources at some point along the path from the source to the sink of the ODUflex. This event causes the failure of the ODUflex Resizing Protocol.

Another situation that can cause the ODUflex Resizing Protocol to fail is if one of the nodes/cards crossed by the ODUflex path does not support the resizing protocol. If an operator wants to support resizable ODUflex on their OTN, they must update the entire network. This again requires significant effort and expense for the operator. Furthermore, if the ODUflex path crosses another operator's domain, it cannot be guaranteed that the other domain supports the resizing protocol.

Therefore, there are at least two scenarios (i.e. lack of resources and presence of nodes/interfaces along the path not able to manage the resizing protocol) that can cause the failure of the protocol and therefore the resizing of the ODUflex.

### SUMMARY

An aspect of the present invention provides a method of facilitating the resizing an existing path in a connection-oriented network from a first size to a second size. The connection-oriented network comprises a plurality of nodes. The method comprises at, a node of the existing path, exchanging control plane signalling with other nodes which advertises available resources on links between nodes. The method further comprises receiving a request to establish a path capable of being resized to the second size. The method further comprises determining, using information acquired by the control plane signalling with other nodes, a new path between nodes capable of supporting the second size. The method further comprises signalling to establish the new path. The method further comprises switching traffic from the existing path to the new path. The method further comprises causing the new path to be resized to the second size.

An advantage of the method is that an existing path (e.g. an ODUflex path) in the network can be resized even if one or more links between nodes along the existing path do not have sufficient capacity to allow the resizing.

Advantageously, the method comprises exchanging control plane signalling with other nodes advertises whether a link supports resizing and the step of determining a new path determines a new path using links which support resizing. The control plane signalling can comprise an OSPF-TE advertisement with a flag indicating whether resizing capability is supported. This has an advantage that the resizing protocol is only performed on an existing path (e.g. an ODUflex path) in the network where nodes support the resizing protocol. In both cases the number of failed attempts to resize the path, called crankbacks, is reduced. Advantageously, a single control plane advertisement carries information about resources (bandwidth) and resizing capability of a link.

Another aspect of the present invention provides apparatus for use at a node of a connection-oriented network for facilitating the resizing an existing path in the network from a first size to a second size. The connection-oriented network comprises a plurality of nodes. The apparatus comprises a first module arranged to exchange control plane signalling with other nodes which advertises available resources on links between nodes. The apparatus further comprises an input for receiving a request to establish a path capable of being resized to the second size. The apparatus further comprises a second module arranged to determine, using information acquired by the control plane signalling with other nodes, a new path between nodes capable of supporting the second size. The apparatus further comprises a third module arranged to signal to establish the new path. The apparatus further comprises a fourth module arranged to switch traffic from the existing path to the new path. The apparatus further comprises a fifth module arranged to cause the new path to be resized to the second size.

Another aspect of the present invention provides a method of operating a node in a connection-oriented network, the connection-oriented network comprising a plurality of nodes. The method comprises, at the first node, exchanging control plane signalling with other nodes which advertises whether a link supports resizing.

Another aspect of the present invention provides apparatus for use at a node of a connection-oriented network, the connection-oriented network comprising a plurality of nodes. The apparatus comprises a module arranged to exchange control plane signalling with other nodes which advertises whether a link supports resizing.

Another aspect of the present invention provides a signal for transmission between nodes of a connection-oriented network. The signal comprising information about a link between nodes of the network and comprises an information element indicating whether resizing is supported.

The signal can be in the form of an OSPF-TE advertisement comprising a field for carrying a set of transport specific flags, with the information element indicating whether resizing is supported is one of the transport specific flags.

The control plane of the network can be a Generalised Multi-Protocol Label Switching (GMPLS) or a Multi-Protocol Label Switching (MPLS) control plane.

The functionality, and any of the functional modules, described here can be implemented in hardware, software executed by a processing apparatus, or by a combination of hardware and software. It will be appreciated that a plurality of the separate modules can be implemented by a single processing apparatus. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable storage medium can be a non-transitory medium. The machine-readable instructions may be stored on an electronic memory device, hard disk, optical disk or other machine-readable storage medium. The machine-readable instructions can be downloaded to the storage medium via a network connection.

### BRIEF DESCRIPTION OF THE DRAWINGS

Embodiments of the invention will be described, by way of example only, with reference to the accompanying drawings in which:

FIG. 1 shows a connection-oriented communications network;

FIG. 2 shows part of an OTN signal structure;

FIG. 3 shows control plane signalling in the network of FIG. 1;

FIG. 4 shows links between nodes of the network of FIG. 3;

FIG. 5 shows a method of resizing a connection performed by a node of the network of FIG. 1;

FIG. 6 shows establishing a new path in the network of FIG. 1;

FIG. 7 shows an example advertisement message;

FIG. 8 shows a node in the network of FIG. 1.

### DETAILED DESCRIPTION

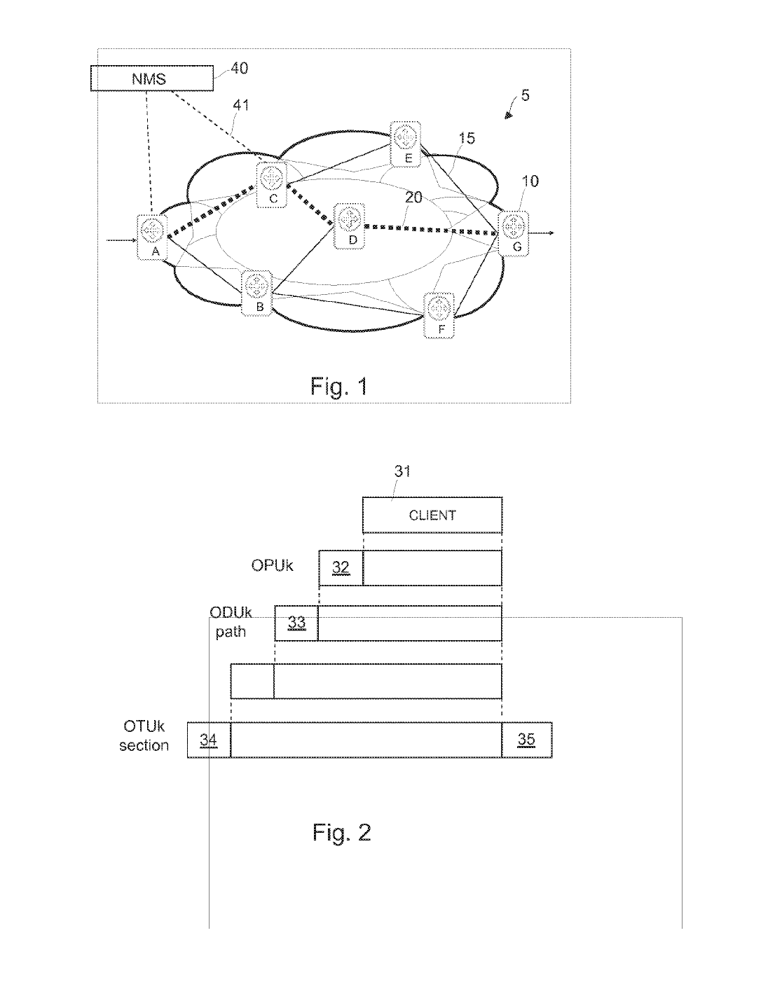

FIG. 1 shows an Optical Transport Network (OTN) 5 comprising nodes 10 (A-G) connected by optical spans 15. An optical span between nodes typically carries a set of wavelength channels called lambdas which are Wavelength Division Multiplexed (WDM) or Densely Wavelength Division Multiplexed (DWDM). A Network Management System (NMS) 40 is connected to nodes 10 by signalling links 41. The Network Management System can be a single entity, as shown in FIG. 1, or it can be distributed across a plurality of entities. Traffic is carried across network 10 by a connection or path. The terms “connection” and “path” are used interchangeably throughout this specification. A path can be a Label Switched Path (LSP). An example path 20 is shown in FIG. 1, connecting node A to node G by a routing A-C-D-G.

Paths can be set-up or torn down using management plane signalling or by control plane signalling. Management plane signalling is carried by signalling links 41 between the NMS 40 and nodes 10. Control plane signalling is sent between nodes 10 of the network. Control plane signalling can be carried in various ways, such as by one or more of: a direct in-band control channel which is routed with a Traffic Engineering (TE)-link of a span which carries the data-plane, with link components carrying control channel payload for the in-band control channel; a direct out-of-band control channel which follows the same route as the TE-Link but is separate from the TE-Link; an indirect control channel which is routed separately from the TE-Link and via at least one intermediate node. Control plane signalling can be sent across at least two different routes to improve resiliency to failures in the signalling path.

Before describing embodiments of the invention in detail, it will be helpful to give some background to Optical Transport Networks. Full details can be found in the ITU-T G.709 family of standards documents. OTN uses a time-multiplexed frame structure. Traffic (called client data in G.709) is mapped into containers within the frame structure. Client data can include Ethernet packets, Synchronous Digital Hierarchy (SDH) traffic, Internet Protocol (IP) packets and various other traffic types. FIG. 2 shows part of the OTN frame structure. The client data 31 is encapsulated with an OPUk overhead 32 to form an Optical Channel Payload Unit (OPUk), with k taking a value k=0, 1, 2, 3, 4 and indicating a particular one of the multiple supported bit rates. The OPUk is intended to be carried end-to-end between a source and sink and is not modified by the network. An Optical Channel Data Unit (ODUk) comprises a payload of an OPUk with an ODUk overhead 33. Again, the letter k can take a value k=0, 1, 2, 3, 4 and indicates a particular nominal bit rate, e.g. ODU1=2.5 Gbps, ODU2=10 Gbps, ODU3=40 Gbps. An Optical Channel Transport Unit (OTUk) comprises a payload of an ODUk with an OTUk overhead 34 and forward error correction 35. Finally, an optical channel (OCh) (not shown) comprises an OTUk with an overhead. The OPUk, ODUk and OTUk are in the electrical domain. The OCh is carried in the optical domain and will be carried over a particular wavelength channel of a Wavelength Division Multiplexed (WDM) transmission system. Additional layers exist in the optical domain, beneath the optical channel. These include an Optical Multiplex Section (OMS), an Optical Transport Section (OTS) and an Optical Physical Section (OPS).

An ODUflex frame structure is the same as the one already defined for the other ODUk (k=0, 1, 2, 3, 4). One strategy for using ODUflex is as follows. Any new Constant Bit Rate (CBR) clients ≦1.238 Gbps are mapped into ODU0. Clients >1.238 Gbps and less than or equal to 2.488320 Gbps are mapped into ODU1. Other CBR clients (with bit rate tolerances up to ±100 ppm) are mapped into ODUflex. Mapping of a supra-2.488 Gbit/s signal into an OPUflex is performed by an asynchronous mapping. New “packet” clients or VLAN are mapped into ODUflex. Mapping of “packet” clients is performed via Generic Framing Procedure-Framed (GFP-F). OTUflex are not specified. ODUflex signals are transported through the optical network using a Higher Order ODUk (HO-ODUk), such as an ODU2, ODU3 or ODU4 signal. The ODUflex is mapped into the HO-OPUk using Generic Mapping Procedure (GMP). Every ODUk (both HO and LO) is divided into Tributary Slots (TS), where each TS can be 1.25 Gbps or 2.5 Gbps. For example, using 1.25 Gbps TSs, an ODU2 has 8 TSs, an ODU3 has 32 TSs and so on. A Tributary Slot includes a part of the OPUk OH area and a part of the OPUk payload area. The bytes of the ODUflex frame are mapped into the ODTU payload area and the ODTU bytes are mapped into the OPUk Tributary Slot or Slots. The bytes of the ODTU Justification Overhead are mapped into the OPUk OH area. Signal structures are shown in ITU-T G.709/Y.1331 “Interfaces for the optical transport network (OTN)”.

In principle, the ODUflex can have any possible bit-rate, between ODU1 and ODU4. However G.709 suggests, for maximum efficiency, that a multiple of the tributary slot size of the next larger HO ODUk be chosen. For example, an ODUflex carrying 12 Gbit/s of GFP-F would choose a multiple of OPU3 tributary slots, with a minimum of ten. A possible network scenario in which an ODUflex path can be established is a connection between two Ethernet switches or Packet Transport Network (PTN) equipments via an OTN network cloud.

ITU-T is defining a new protocol for the resizing of ODUflex paths, which allows adding or removing TSs associated to such ODUflex path inside the HO-ODUk carrying it. However, if there are no more available TSs on any of the links of the path, the resizing procedure fails. The resizing protocol is being developed as an ITU-T recommendation “Hitless Adjustment of ODUflex (HAO)”.

According to an embodiment of the invention, control plane signalling 30 is sent between nodes 10 of the network 5. The control plane signalling advertises information about at least one of:
(i) resource availability on links (e.g. in terms of a number of free TSs in the HO-ODUk carrying the ODUflex);
(ii) capability of a link to support the Resizing Protocol.
   Each node 10 sends advertisement messages which advertise at least one of the items described above, and receives advertisement messages from other nodes 10. A node 10 uses the resource availability information in received advertisements to construct a table of available resources for links in the network 5. Part of an example table is shown below:

| Link | Available resources (TSs) |
|---|---|
| AB | 10 |
| AC | 5 |
| BD | 4 |

A node 10 uses the capability information in received advertisements to construct a table indicating which links in the network 5 support the resizing protocol. Part of an example table is shown below:

| Link | RP supported? |
|---|---|
| AB | Yes |
| AC | Yes |
| BD | No |

The control plane signalling can be in the form of OSPF-TE advertisements for OTN networks described in IETF draft document: draft-ceccarelli-ccamp-gmpls-ospf-g709-04.

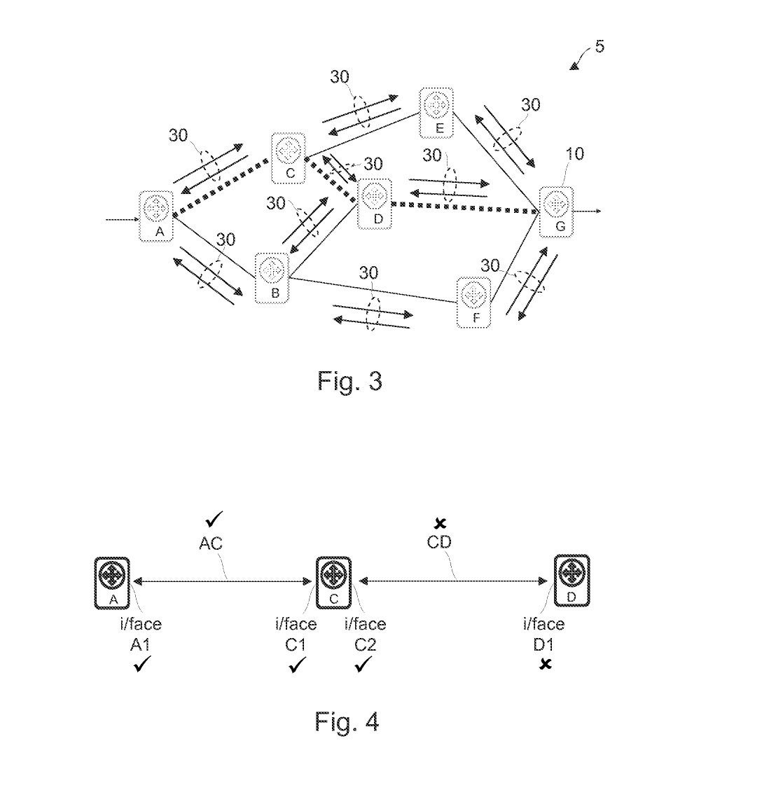

FIG. 4 shows part of the network of FIG. 3, showing nodes A, C and D. A link AC exists between interface A1 on node A and interface C1 on node C. A link CD exists between interface C2 on node C and interface D1 on node D. For each interface there is a possibility that the interface supports resizing, or does not support resizing. The symbol next to each interface indicates whether resizing is supported. Each interface (A1, C1, C2, D1) transmits an OSPF-TE link advertisement to advertise properties of a link at that interface. Before advertising the capabilities of a link, there is negotiation between the nodes at the respective ends of the link as to what properties will be advertised. If both interfaces at the respective ends of a link support the resizing capability, the advertisement of the link sent by both interfaces will indicate that resizing is supported. In FIG. 4, interfaces A1 and C1 both support resizing, so link AC is advertised indicating that resizing is supported. If only one of the interfaces at the respective ends of a link supports the resizing capability, the advertisement of the link sent by both interfaces will indicate that resizing is not supported. In FIG. 4, interface C2 supports resizing and interface D1 does not support resizing, so link CD is advertised indicating that resizing is not supported.

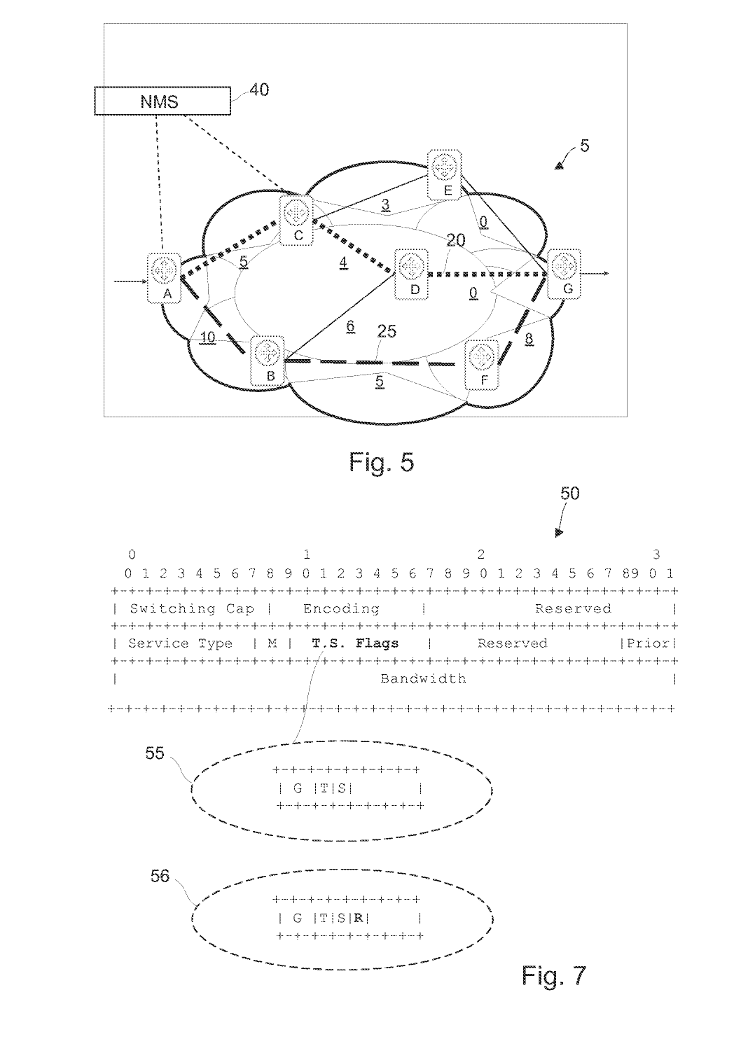

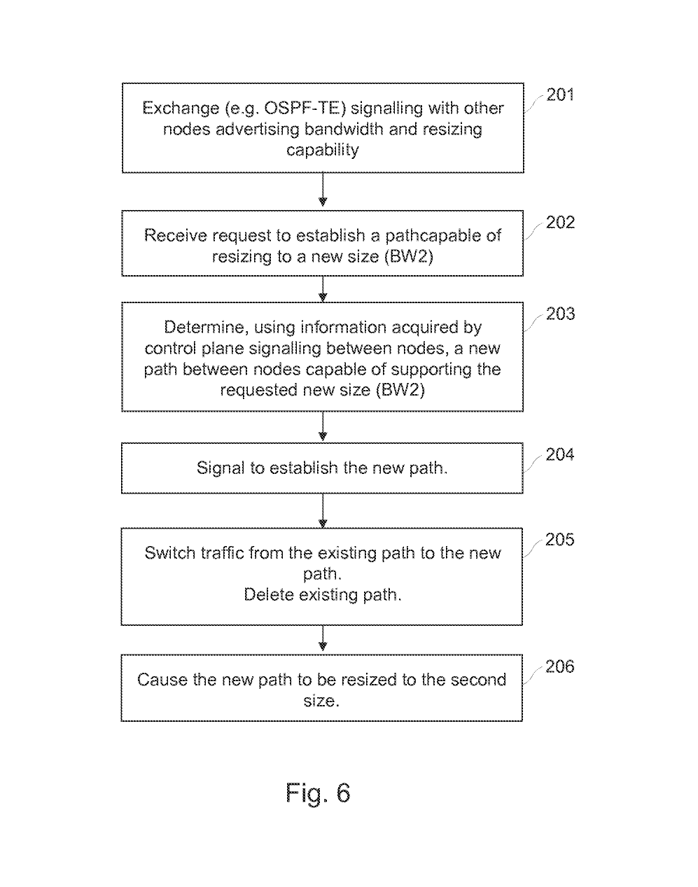

FIG. 5 shows a method performed by a node 10 of the network. FIG. 6 shows an example network in which a new path is established. Advantageously, the method is performed by an end node (called an ingress node) of an existing path which requires resizing. A connection, such as an ODUflex, already exists and passes via the end node that performs the method. The method can be performed by node A of the existing path 20 in the example network of FIG. 6.

At step 201 the node exchanges control plane signalling (such as OSPF-TE advertisements) with other nodes 10 and constructs a table of available resources on links of the network and constructs a table of the capability of other nodes 10 to support ODUflex resizing protocol. Advantageously, the signalling at step 201 begins when the node is first turned on and continues on a periodic basis (e.g. sending updated advertisements upon expiry of a timer, such as every few seconds or minutes, or whenever a change occurs at the node.)

At step 202 a request is received to establish a new path that is capable of being resized to a requested size (BW2). The request may be received in response to a failure by the management plane to resize existing path 20 using the Resizing Protocol. For example, one of the HO-ODUks on a link between nodes that transports the ODUflex along existing path 20 may not have sufficient resources to allow the existing path 20 to be increased from a first bandwidth (BW1) to a second bandwidth (BW2). The HO-ODUk may have insufficient TSs. Alternatively, at least one of the nodes/interfaces along the existing path 20 are unable to perform the resizing because they do not support the RP, or for any other reason that causes the failure of the protocol. The request received at this step is a request to establish a new ODUflex path that can be resized to a specified bandwidth (BW2). The request can specify an actual bandwidth required, or a bandwidth delta (increase or decrease) compared to the bandwidth of the existing path.

At step 203 the node determines, using the stored information, a new path between nodes capable of supporting a resize to the requested bandwidth (BW2). For example, if the existing path requires a bandwidth which increases by 2 TSs, step 203 will select a new path which has at least 2 TSs free on each link between end nodes of the path. FIG. 6 shows a new path 25 between nodes A and G with the new routing A-B-F-G. If more than one possible path which can support the requested bandwidth, step 203 can use selection criterion/criteria to select between possible paths. A possible selection criterion is link cost, etc. Step 203 only considers those links that support the resizing protocol, when calculating the new path, to avoid any further failures of the RP.

At step 204, the node sends signalling to establish the new path. This can be an RSVP-TE Path message which is sent along the new path that is to be established. Initially, the new path is established with the same size as the existing path. However, it is capable of being resized to the required new size. A resizable ODUflex is established at this step.

With the new path established, step 205 switches traffic to the new path. Advantageously, the switch occurs in a manner which minimises traffic loss during the switchover. Advantageously, the switch occurs in a manner which is hitless. One technique for the switchover establishes Sub Network Connection Protection (SNCP) protection (1+1 protection) on the existing path and new path. The existing path (20, FIG. 6) is deleted. This can be achieved by sending control plane signalling along the path to instruct nodes to delete the path.

At step 206 the new path is resized to the new size. In the example described here, the path is resized to BW2. Advantageously, the resizing at step 206 is performed by the management plane Resizing Protocol. The node can notify the management plane at step 206 that a new path has been set up, and details of the new path. The Resizing Protocol can then initiate the RP along the new path.

The order of the steps shown in FIG. 6 can be varied from that shown in the Figure. For example, control plane signalling at step 201 can occur in response to receiving the request at step 202.

Referring to FIG. 6 in more detail, an ODUflex is set up on path 20 between nodes A and F with the routing A-C-D-G. Suppose that this ODUflex is transported, for routing purposes, by different HO-ODUk along the paths (e.g. ODU2 from A to C, ODU3 from C to D and ODU2 from D to G). Consider that, due to an increase of client packets this ODUflex has to increase from 5 to 8 TSs. Therefore, an additional 3

TSs are required. The Resizing Protocol can fail if one of the HO-ODUks along the path does not have sufficient spare resources to meet the requested resize. FIG. 6 shows, against each link, the number of available TSs. Link AC has 5 available TSs, link CD has 4 available TSs, and link DG has 0 available TSs. As link DG does not have sufficient resources (e.g. the ODU2 from D to G is fully equipped and no TS are available for the “expansion” of the ODUflex), the RP will fail. The Resizing Protocol can also fail if one of the links along the path does not support the Resizing Protocol.

In step 202 of the method described above a request is received to establish a path capable of being resized to the second size. If the management plane knows that performing the Resizing Protocol on an existing path will fail, it can send the request at step 202 without first trying to perform the RP.

An ODUflex can be resized by an increase in the size of the path (i.e. BW2>BW1) or by a decrease in the size of the path (i.e. BW2<BW1). Failure of the Resizing Protocol due to the amount of free resources being insufficient to support the new size, will usually occur if the ODUflex is being increased in size. Failure of the Resizing Protocol due to a link not supporting the RP can occur irrespective of whether the ODUflex is being increased or decreased in size.

A suitable OSPF-TE advertisement for OTN networks is described in IETF draft: draft-ceccarelli-ccamp-gmpls-ospf-g709-04. FIG. 7 shows the OSPF-TE bandwidth accounting sub-tlv 50 described in this document. Bandwidth information is carried in field 52. Field “T.S. Flags” (Technology Specific Flags) 55 is used for the advertisement of OTN specific capabilities. The document defines the utilisation of the first four flags (two of them are merged into the G field). The lower part of FIG. 6 shows a modified form 56 of field 55 in accordance with an embodiment of the invention. A fifth flag, called R, is added for the advertisement of ODUflex resizing capability. Flag R can take two values:
R=0 indicates ODUflex resizing capability is NOT supported
R=1 indicates ODUflex resizing capability is supported.
   OTN specific field values for the other part of field 55 are:

Service Type (8 bits): Indicates the type of ODUk/ODUflex supported by the TE link. Possible values are: 0—ODU0; 1—ODU1; 2—ODU2; 3—ODU3; 4—ODU4; 10—ODU2e; 20—ODUflex non resizable; 21—ODUflex resizable.

Technology Specific Flags (8 bits): Indicate OTN specific capabilities and are defined as follows:

G field (merge of bit 11 and 12): Indicates the granularity of the Tributary Slot used on the advertised TE link. Possible values are: 0—1.25 Gbps; 1—2.5 Gbps; 2—3 for future uses.

T Flag (bit 13): Indicates whether the advertised bandwidth can be terminated on the related interface or not, where: 0—Advertised service type cannot be terminated; 1—Advertised service type can be terminated.

S Flag (bit 14): Indicates whether the advertised bandwidth can be switched on the related interface or not, where: 0—Advertised service type cannot be switched; 1—Advertised service type can be switched.

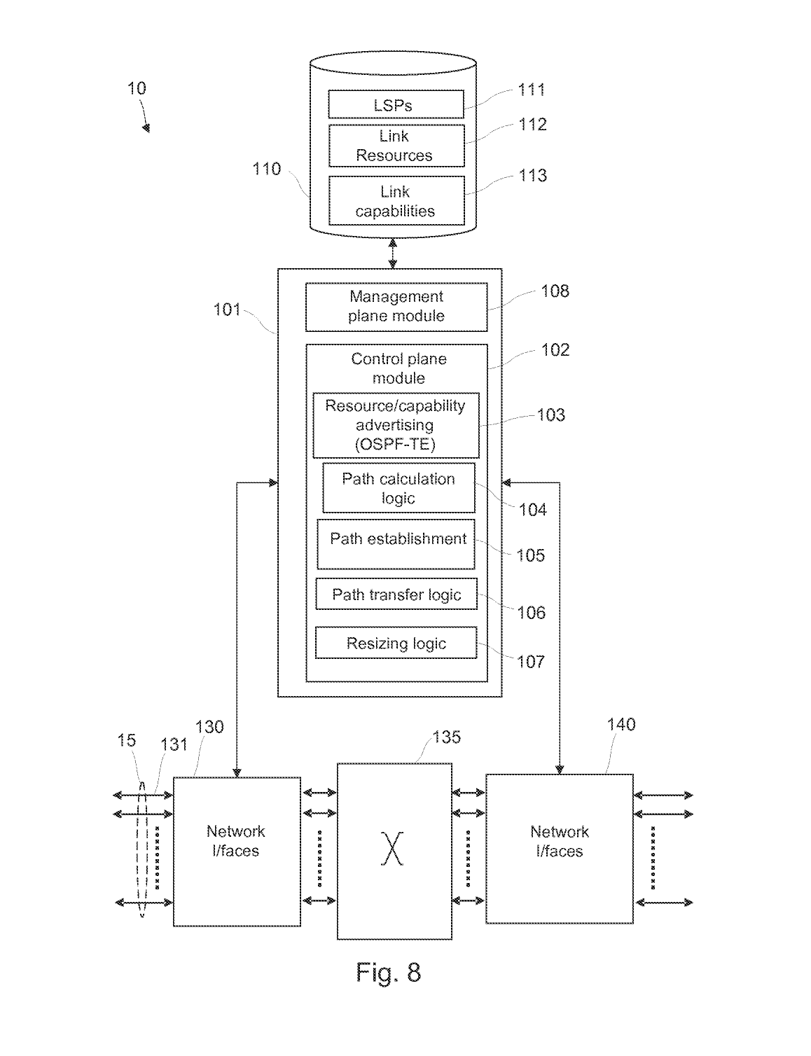

FIG. 8 shows a node 10 which is capable of performing the method described above. The node 10 has network interfaces 130, 140 for connecting to network spans. FIG. 6 shows a span 15 carrying a set of wavelength channels (lambdas) 131. The node can have a switching function 135 for switching traffic in the optical domain and/or in the electrical domain between ports of respective network interfaces 130, 140.

A controller 101 of the node is connected to the network interfaces 130, 140 and is operatively connected to storage 110. Controller 101 comprises a control plane module 102 and a management plane module 108. The control plane module 102 comprises a module 103 for performing advertising of link resource availability and node capabilities (i.e. if a node supports the RP). This module 103 sends control plane signalling (e.g. OSPF-TE) messages to other nodes. Control plane signalling can be carried over an overhead portion of an OTN signal. This module also receives advertisements from other nodes and constructs a table 112 of link resources and a table 113 of node capabilities. Module 104 comprises path calculation logic to determine an alternative network path which meets the bandwidth requirements in a request. Module 105 performs control plane signalling (e.g. RSVP-TE signalling) to establish a new path. Module 106 performs control plane signalling (e.g. RSVP-TE signalling) to transfer traffic from an existing path to a new path. Module 107 comprises logic to cause the new path to be resized. This module can co-ordinate with the management plane module 108 to cause the Resizing Protocol to be implemented. Control plane module 102 can send control plane signalling via an overhead on link 15 or by a separate link between nodes 10. The management plane module 108 interfaces with the management plane of the network 5.

FIG. 8 shows a general node 10 of the network 5. The method shown in FIG. 6 is typically performed by an end node (e.g. an ingress node) of an existing path, and uses the various modules shown in FIG. 8. An intermediate node in the network may comprise all of the modules shown in FIG. 8, or just a sub-set of the modules shown in FIG. 8. An intermediate node will typically always comprise the resource/capability advertising module 103.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of facilitating resizing an existing path in a connection-oriented network from a first size to a second size, the connection-oriented network comprising a plurality of nodes, the method comprising, at a node of the existing path:
exchanging control plane signalling with other nodes which advertises available resources on links between nodes;
receiving a request to establish a path capable of being resized to the second size;
determining, using information acquired by the control plane signalling with the other nodes, a new path between nodes capable of supporting the second size;
signalling to establish the new path;
switching traffic from the existing path to the new path; and
causing the new path to be resized to the second size.

2. The method according to claim 1, further comprising exchanging control plane signalling with the other nodes which advertises whether a link supports resizing, and wherein the step of determining the new path determines the new path using links which support resizing.

3. The method according to claim 2, wherein the control plane signalling comprises an Open Shortest Path First-Traffic Engineering (OSPF-TE) advertisement with a flag indicating whether a resizing capability is supported.

4. The method according to claim 1, wherein the step of signalling to establish the new path uses control plane signalling to establish the new path.

5. The method according to claim 1, wherein the step of switching traffic from the existing path to the new path comprises deleting the existing path after traffic has been switched to the new path.

6. The method according to claim 5, wherein deleting the existing path comprises using control plane signalling to delete the existing path.

7. The method according to claim 1, wherein the step of receiving the request to establish the path occurs following a failure of a management plane protocol to resize the existing path.

8. The method according to claim 1, wherein the connection-oriented network is an optical transport network (OTN) and the existing path is an ODUFlex.

9. A node to be used in a connection-oriented network to facilitate resizing an existing path in the network from a first size to a second size, the connection-oriented network comprising a plurality of nodes, the node comprising:
a first module arranged to exchange control plane signalling with other nodes which advertises available resources on links between nodes;
an input for receiving a request to establish a path capable of being resized to the second size;
a second module arranged to determine, using information acquired by the control plane signalling with other nodes, a new path between nodes capable of supporting the second size;
a third module arranged to signal to establish the new path;
a fourth module arranged to switch traffic from the existing path to the new path; and
a fifth module arranged to cause the new path to be resized to the second size.

10. The node according to claim 9 wherein:
the first module is further arranged to exchange control plane signalling with the other nodes which advertises whether a link supports resizing, and
the second module is to determine the new path by being arranged to determine the new path using links which support resizing.

11. (canceled)

12. (canceled)

13. (canceled)

14. (canceled)

15. (canceled)

16. The node of claim 9, wherein the control plane signalling comprises an Open Shortest Path First-Traffic Engineering (OSPF-TE) advertisement with a flag indicating whether a resizing capability is supported.

17. The node of claim 9, wherein the third module is further arranged to delete the existing path after traffic has been switched to the new path by the fourth module.

18. A non-transitory machine-readable storage medium comprising instructions that, when executed by a processor of a processing apparatus, cause the processing apparatus to facilitate resizing an existing path in a connection-oriented network that comprises a plurality of nodes from a first size to a second size by performing operations comprising:
exchanging control plane signalling with other nodes which advertises available resources on links between nodes;
receiving a request to establish a path capable of being resized to the second size;
determining, using information acquired by the control plane signalling with the other nodes, a new path between nodes capable of supporting the second size;
signalling to establish the new path;
switching traffic from the existing path to the new path; and
causing the new path to be resized to the second size.

19. The non-transitory machine-readable storage medium of claim 18, wherein the new path utilizes links that support resizing, and wherein the operations further comprise:
exchange control plane signalling with the other nodes, wherein the control plane signalling advertises whether a link supports resizing.

20. The non-transitory machine-readable storage medium of claim 19, wherein the control plane signalling comprises an Open Shortest Path First-Traffic Engineering (OSPF-TE) advertisement with a flag indicating whether a resizing capability is supported.

21. The non-transitory machine-readable storage medium of claim 18, wherein the signalling to establish the new path uses control plane signalling.

22. The non-transitory machine-readable storage medium of claim 18, wherein the operations further comprise deleting the existing path after traffic has been switched to the new path.

23. The non-transitory machine-readable storage medium of claim 22, wherein said deleting of the existing path uses control plane signalling.

23. The non-transitory machine-readable storage medium of claim 18, wherein the processing apparatus is to receive the request to establish the path following a failure of a management plane protocol to resize the existing path.

24. The non-transitory machine-readable storage medium of claim 18, wherein the connection-oriented network is an optical transport network (OTN) and the existing path is an ODUFlex.
